(19) United States
(12) Patent Application Publication
(10) Pub. No.: US 2018/0261223 A1
(43) Pub. Date: Sep. 13, 2018

(54) DIALOG MANAGEMENT AND ITEM FULFILLMENT USING VOICE ASSISTANT SYSTEM

(71) Applicant: Amazon Technologies, Inc., Seattle, WA (US)

(72) Inventors: Mehul Jain, Redmond, WA (US); Tushar Agrawal, Bothell, WA (US); Elite Che, Seattle, WA (US); Shilippi Garg, Mercer Island, WA (US); Teng Gu, Bellevue, WA (US); Abhay Saxena, Seattle, WA (US)

(21) Appl. No.: 15/627,136

(22) Filed: Jun. 19, 2017

Related U.S. Application Data
(60) Provisional application No. 62/470,778, filed on Mar. 13, 2017.

(51) Int. Cl. G10L 15/26; G06Q 30/06

(52) U.S. Cl. CPC G10L 15/265; G06Q 30/0601

(57) ABSTRACT

Dialog management may be performed by a voice assistant system where the dialog pertains to a shopping experience that enables a user to order one or more items using voice-activated commands provided during a dialog exchange with the voice assistant device. In some embodiments, the personal assistant system may enable a user to order items, select fulfillment details for the items, pay for the items, and/or perform other related tasks to enable the user to obtain the items using voice activated commands and without reliance on a graphical user interface. In various embodiments, the personal assistant system may select fulfillment options for a user, or may assign fulfillment to a particular service based on audio responses received from a user. The personal assistant system may leverage prior user interaction data, user profile information, and/or other user information during interaction with a user to supplement voice inputs received from a user.

### CROSS-REFERENCE TO RELATED APPLICATION

This application claims priority to commonly owned, U.S. Patent application 62/470,778 filed Mar. 13, 2017, and entitled “Dialog Management And Item Fulfillment Using Voice Assistant System,” which is herein incorporated by reference in its entirety.

### BACKGROUND

Many different ways have been introduced to allow users to interact with computing devices, such as through use of mechanical devices (e.g., keyboards, mice, etc.), touch screens, motion, gesture, and even using natural language input such as speech. Furthermore, many of these computing devices are further connected to remote computing resources, such as cloud-based resources, that extend functionality afforded by the local computing devices.

As computing devices in homes and offices continue to evolve, users expect a more seamless and timely experience when interacting with cloud-based resources through the local computing devices. Additionally, users expect a more robust set of services when interacting with cloud-based resources through the local computing devices. In particular, users expect accurate, intuitive, and relatively quick interactions with computing devices in order to instruct the computing devices to perform desired functions.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative computing environment.

FIG. 2 is a block diagram of an illustrative computing architecture.

FIG. 3 is a block diagram of an illustrative dialog graph that includes an example node.

FIG. 4 is a block diagram of an illustrative dialog graph that includes a subgraph.

FIG. 5 is a block diagram of an illustrative first dialog graph that includes call to a second dialog graph.

FIG. 6 is a block diagram of the illustrative second dialog graph referenced in FIG. 5.

FIGS. 7A and 7B are block diagrams showing illustrative actions of a fulfillment engine.

### DETAILED DESCRIPTION

This disclosure is directed to dialog management using a voice assistant system where the dialog pertains to a shopping experience that enables a user to order one or more items using voice-activated commands provided during a dialog exchange with the voice assistant device. The voice assistant device may include any system or device that receives audio commands from a user, processes the audio, possibly using speech to text algorithms and/or natural language processing (NLP) algorithms, to determine text, returns a reply based on the text, converts the reply to an audio output using text to speech algorithms, and causes a speaker to output the audio output. A process may include multiple “turns”, which define a dialog including multiple related instances of the process described above. Unlike stand-alone question-response interactions, a dialog process may leverage words, data states, and/or other information during different turns or portions of the dialog, which may enable a more natural language interaction between a user and the voice assistant system. Examples of voice assistant systems include Alexa® provided by Amazon.com® of Seattle, Wash., Siri® provided by Apple Corp.® of Cupertino, Calif., and Cortana® provided by Microsoft Corp.® of Redmond, Wash. The voice assistant system may include a user device that typically includes at least a network interface, a microphone, and a speaker. The user device may be a smart phone, a dedicated device, and/or other devices controlled by users and located proximate to the users. The voice assistant system may include a service engine, which may be stored by the user device, in a remote location (e.g., via remote computing devices such as in a cloud computing configuration, etc.), and/or a combination of both.

In some embodiments, the personal assistant system may enable a user to order items, select fulfillment details for the items, pay for the items, and/or perform other related tasks to enable the user to obtain the items using voice activated commands and without reliance on a graphical user interface. In various embodiments, the personal assistant system may select fulfillment options for a user, or may assign fulfillment to a particular service based on audio responses received from a user. The personal assistant system may leverage prior user interaction data, user profile information, and/or other user information during interaction with a user to supplement voice inputs received from a user. For example, if a user provides a voice command “I'd like to buy some black shoes,” the personal assistant system may associate this request with a particular user that has a user profile and user interaction history. The user profile and user interaction history may indicate prior orders of shoes by the user, which may indicate a size of a shoe, a brand of a shoe, and/or other useful information which may be leveraged from the user profile and user interaction history in fulfilling a request for the user. The personal assistant system may then provide a reply that includes a shoe having the size and possible from a brand previously associated with the user. By leveraging user profiles and user interaction history, the personal assistant system may respond to requests that may not include some certain details, such as a size and brand preference.

This disclosure discusses a shopping domain ontology, which is associated with a store and category agnostic flow. Below, a high level diagram of concepts and workflows are provided to describe parameters and example dialog with the personal assistant system. An illustrative scheme for optimized conversation paths (e.g., in a general purchasing conversation), an agent would ask several questions like “What is an address for delivery?”, “What is your preferred time of delivery”, “What is your desired tip?”, etc. The general modus operandi is to construct data backed defaults (or a user profile) to reduce the number of turns by asking fewer questions. Illustrative optimizations over the generic shopping workflow are provided below:
1) Smart Store Selection: selection of a store or fulfillment service to provide one or more ordered items to a user.
2) Default Address & Payment Selection: Instead of asking for a delivery address, the system may assume the user wants it delivered at an address associated with the user instead of asking a question (“Which address would you want it delivered to?”). However, the system may confirm an intent, such as an intended address, which may prompt a user to make changes if needed.
3) Smart Delivery Slot Selection: Rather than asking a user for a delivery slot (e.g., deliver between 6 pm and 8 pm), the voice assistant system (VAS) may default to a next available delivery slot. The system may employ machine learning techniques to learn user's preferred delivery slot (evenings, mornings, next available etc.). The system may default to the computed slot and build language capabilities for users to correct the slot on a need-by basis. The following example shows a common approach.
   a. Example 1 (common approach)
User) Order ice-cream.
VAS) I found X. It is $Y and requires attended delivery. Would you like to buy it?
User) Yes
VAS) What time do you want it delivered?
User) After 7:00 pm
VAS) The delivery can be made between 8:00 pm-10:00 pm today. Would you like to buy it?
User) Yes
   b. Example 2 (learned approach)
User) Order ice-cream.
VAS) I found X. It is $Y and can be delivered between 8:00 pm-10:00 pm and requires attended delivery. Would you like to buy it?
User) Yes
   c. Example 3 (learned approach with user edit)
User) Order ice-cream.
VAS) I found X. It is $Y and can be delivered between 8:00 pm-10:00 pm and requires attended delivery. Would you like to buy it?
User) Can you deliver after 10:00 pm
VAS) The delivery can be made between 10:00 pm-12:00 am tonight. Would you like to buy it?
User) Yes
4) Personalized search results over guided search: The system may use past purchase data to provide personalized recommendations (your favorite coffee when you just ask for coffee) than asking questions about the kind of coffee you want. The system may use guided search when personalized recommendations cannot be performed leveraging purchase data. Guided search may prompt additional questions about a request in order to fulfill the request, such as questions about brand, size, flavor, and/or other attributes. In some embodiments, an abbreviated guided search may be executed when some, but not all attributes can be assumed based on prior user history (including user interactions in a current session).
5) Product Correction: The system may use personalized search results, but may enable a user to correct results, such as the product if need be. (Ex: VAS presents the frequently purchased Aveeno shampoo from a user's order history even though the user has also purchased baby shampoo. The system may enable the user to correct the product by interrupting VAS during a dialog (or at other times) and saying “VAS, I need baby shampoo”, etc.).
6) Smart Product Titles: The system may present a short version of a title of an item. This may include truncating longer version of titles, for example, The short title may be used if the user has previously interacted with the item. If no prior interaction exists, a full title or longer title may be used at least once to inform the user of adequate details of the item.
7) Smart Pack sizing and quantity: The system may default to the correct pack size and quantity (e.g., two 1 gallon milk bottles) based on a user's order history and let the user correct as needed (“VAS, order two of them”, etc.).
8) Learning Tipping behaviors: The system may learn a user's tipping behavior (No Tip, 15%, 25% etc.) and default to a certain tipping action rather absent contrary instructions from the user. The default tip may be included in a summary to enable the user to change the tip, for example.

The techniques and systems described herein may be implemented in a number of ways. Example implementations are provided below with reference to the following figures.

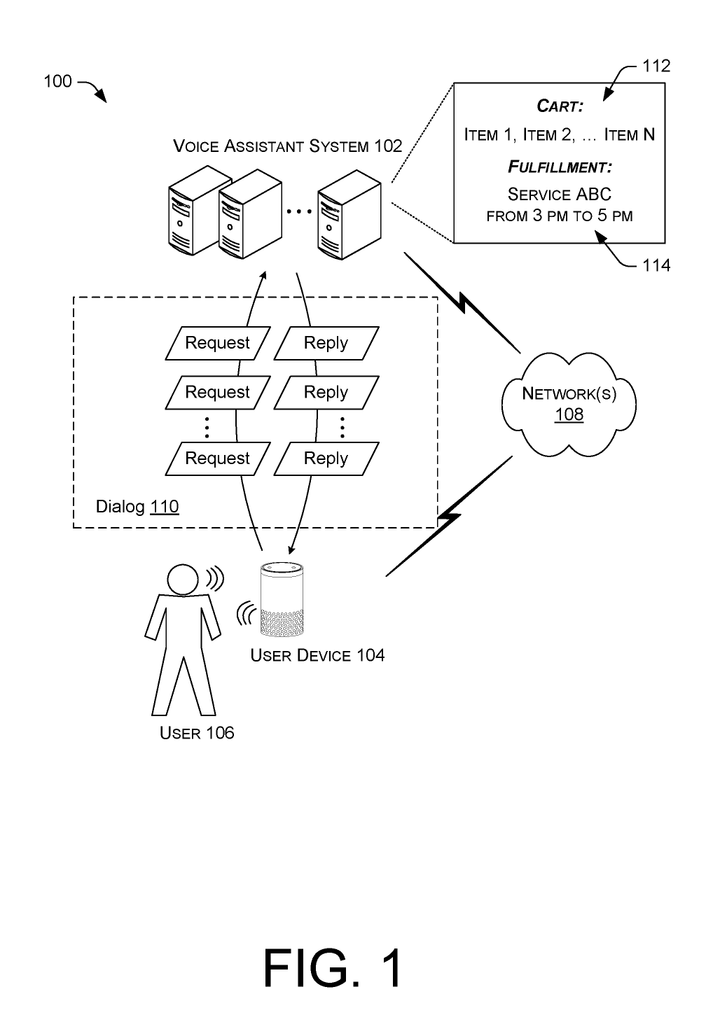

FIG. 1 is a schematic diagram of an illustrative computing environment 100. The environment 100 may include a voice assistant service (VAS) 102 that exchanges data with a user device 104, such as audio data and voice data, to facilitate a dialog with a user 106 of the user device 104. The user device 104 may be one of any electronic devices that are at least partially controlled using speech commands issued by the user 106. In some embodiments, the user device 104 may be a dedicated speech recognition device that includes few or no other input controls (e.g., few or no buttons, motion devices, imaging devices, etc.). Instead, the user device 104 may receive input from users by receiving spoken commands, which are converted to signals by the user device 104 and/or by a could service, and then processed, such as by an exchange of data with the VAS 102. The VAS 102 may be any service that provides data to the user device 104 in response, directly or indirectly, from the user device 104. The VAS 102 need not be configured for speech recognition since speech recognition may be performed prior to sending a request to one of the services in some instances. The VAS 102 may provide may different types of information, entertainment, or data, such as by proving music, directions, documents, performing tasks (adding things to lists, setting reminders, starting a timer, adding a calendar event, etc.), and so forth. As discussed herein, the VAS may be configured to engage in a dialog 110 to receive an order of one or more items from the user, including facilitating selection and confirmation of items, and cause those items to be fulfilled and delivered to the user using a natural and concise dialog, as described in the examples below. The VAS 102 and the user device 104 may be in communication via one or more networks 108, which include wired and/or wireless networks.

An exchange between the VAS 102 and the user device 104 may be quantified as “turns”, which measure a number of back-and-forth exchanges. When a user asks a question or issues a request, the request may be received by the user device 104 and possibly by the VAS 102. The user device 104 and/or the VAS 102 may, in turn, process the request and generate a system reply, which may be issued back to the user 106. This single back and forth exchange is referred to herein as a single “turn”. While some requests may be satisfied in a single turn, other requests may require or include multiple turns before the user 106 achieves an intended result or goal. The combination of turns is referred to as the dialog 110. The dialog 110 may use information obtained in prior turns to inform a reply in a current turn. The dialog 110 may be structured according to dialog graphs, which are described in detail below. A dialog graph has nodes that represent different stages of a process, such as a selection of an item, a checkout process, a question about an item, and so forth. Each node may include edges, which enable the VAS 102 to determine what information may be received at a particular node to enable the VAS to advance to a next node and progress through a particular dialog graph to a conclusion or desired outcome.

As the user 106 interacts with the VAS 102, the VAS may compile a cart 112 or order of items. From time to time, the VAS may announce details about the cart, such as details about the items in the cart (e.g., item titles, description, etc.), price information, quantity information, and/or other information about items in the cart.

The VAS 102 may include fulfillment details 114, such as an assigned service to fulfill at least some of the items in the cart 112. In some embodiments, the VAS 102 may determine a service that is able to fulfill an order or at least part of an order based at least in part on prior fulfillment services used by the user and/or based on information associated with the user (e.g., location, timeframe for delivery, etc.). The VAS 102 may determine a service best suited to fulfill an order, such as when the order includes multiple items that are available from a plurality of different services. In some embodiments, the VAS may recommend a service to a user, such as when the user has not used a particular service before, but the service may be beneficial to the user to provide the items to the user.

The VAS 102 may also include details of a fulfillment 114, such as a time slot for a delivery. The time slot may be determined based at least in part on prior history associated with a user, such as times associated with prior orders. For example, if a user's history includes a preference for deliveries after 5 pm, but includes no preference for deliveries before 5 pm, then the VAS 102 may assume (conclude) that the user desires a subsequent delivery after 5 pm. However, if no deliveries are available after 5 pm, the VAS 102 may ask the user, via the dialog 110, if a delivery before 5 pm is acceptable. Of course, a user may be able to change an assumed delivery time by providing further dialog to make this change, such as by explicitly stating a desired delivery time.

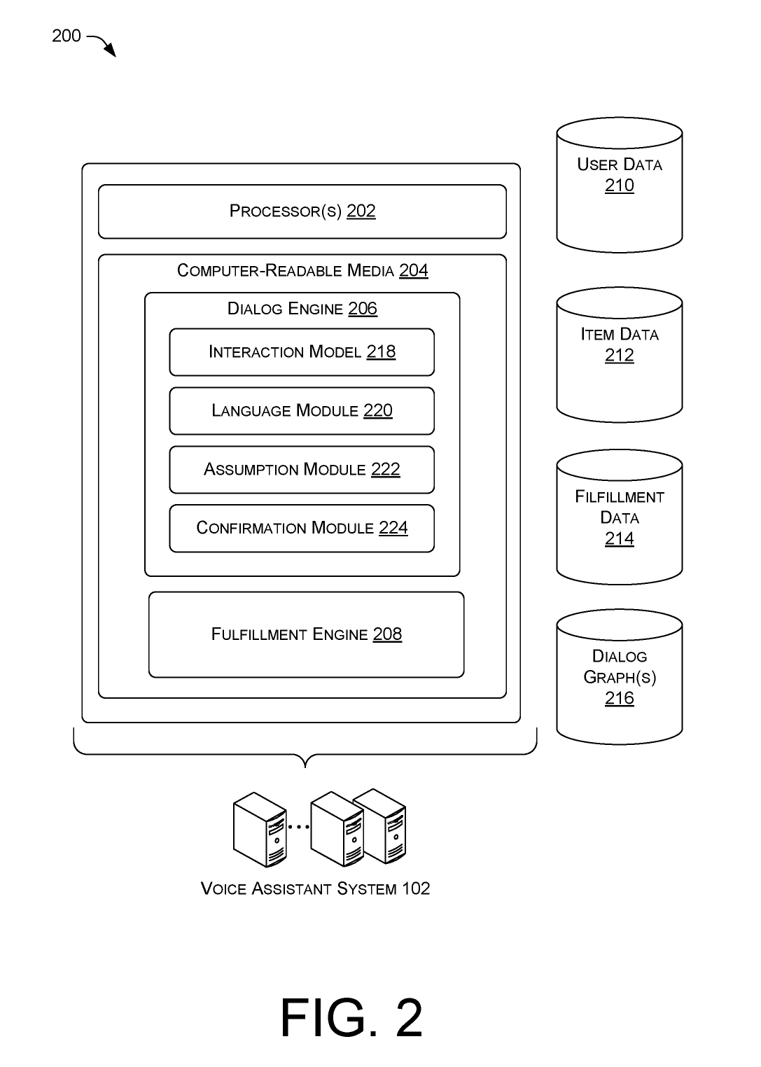

FIG. 2 is a block diagram of an illustrative computing architecture. The computing architecture 200 may be implemented in a distributed or non-distributed computing environment. The computing architecture 200 may include one or more processors 202 and one or more computer-readable media 204 that stores various modules, applications, programs, or other data. The computer-readable media 204 may include instructions that, when executed by the one or more processors 202, cause the processors to perform the operations described herein.

Embodiments may be provided as a computer program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks.

In some embodiments, the computer-readable media 204 may store a dialog engine 206 and a fulfillment engine 208, which are described in turn. The VAS 102 may have access to various data stores, including user data 210, item data 212, fulfillment data 214, and dialog graph(s) 216. The dialog engine 206 may further include an interaction model 218, a language module 220, an assumption module 222, and a confirmation module 224. The dialog engine 206 and/or the fulfillment engine 208 may employ machine learning algorithms as discussed herein. The engines and data stores may be stored together or in a distributed arrangement.

The dialog engine 206 may facilitate performance of the dialog 110 with the user 106 as shown and described with reference to FIG. 1. The dialog engine 206 may interact with the user, via the user device, by traversing dialog graph(s) 216 by deploying the interaction model 218. The interaction model 218 may manage a state of a shopping dialog by describing the history of turns given user input and any system executions on behalf of the user. Thus, during interaction with the dialog engine 206, a user may provide voice requests that are processed in accordance with the interaction model 218. The interaction model 218 may determine which nodes exist within certain dialog graphs, and what the endpoints are for those nodes (e.g., what other nodes can be accessed from a particular node.).

The language module 220 may process language inputs received from the user. For example, the language module 220 may deploy automated speech recognition (ASR) algorithms and/or natural language processing (NLP) algorithms to facilitate a dialog with a user. In some embodiments, the language module 220 may determine means for pronouns and/or anaphoras by analyzing use of language rules and information collected from a user from a prior user input, turn, session, and/or from user history. In some embodiments, anaphoras and/or pronouns may be defined base on an order of turns for a particular graph or subgraph currently being traversed by a user while interacting with the dialog engine 206.

The assumption module 222 may make predictions, conclusions, and/or assumptions as to an intent of a user based on user data, such as user profile data, user history and/or information obtained during a particular state or interaction with one or more dialog graph(s). For example, the assumption module 222 may process a request for “milk” to mean “one gallon of organic whole milk from XYZ dairy farms”. In some embodiments, the assumption module 222 may calculate or determine a confidence score for an assumption. For example, the assumption module 222 may determine an confidence score for a possible result, and may provide the result to the user via a user device based on the confidence score or may refrain from providing the result based on the confidence score (and likely request additional information instead, possibly via the confirmation module 224).

The confirmation module 224 may determine when and/or what information to confirm to a user during interaction with the user via a user device. The confirmation module 224 ensures that the VAS and dialog engine 206 performs as a user intends, such as by adding the items that the user intended to an order. For example, a user may request that “milk” be added to the order. The confirmation module 224 may confirm this in many different ways, each having a different specificity. For example, the addition may be confirmed as “your milk”, “one gallon of your milk”, “one gallon of whole milk”, and so forth. The confirmation module 224 may determine when to provide a confirmation and what information to provide in the confirmation. The confirmation module 224 may be updated from time to time via a machine learning algorithm to improve a utility of the confirmation module. For example, user request for additional confirmation information or correction of items may be used to train the confirmation module 224.

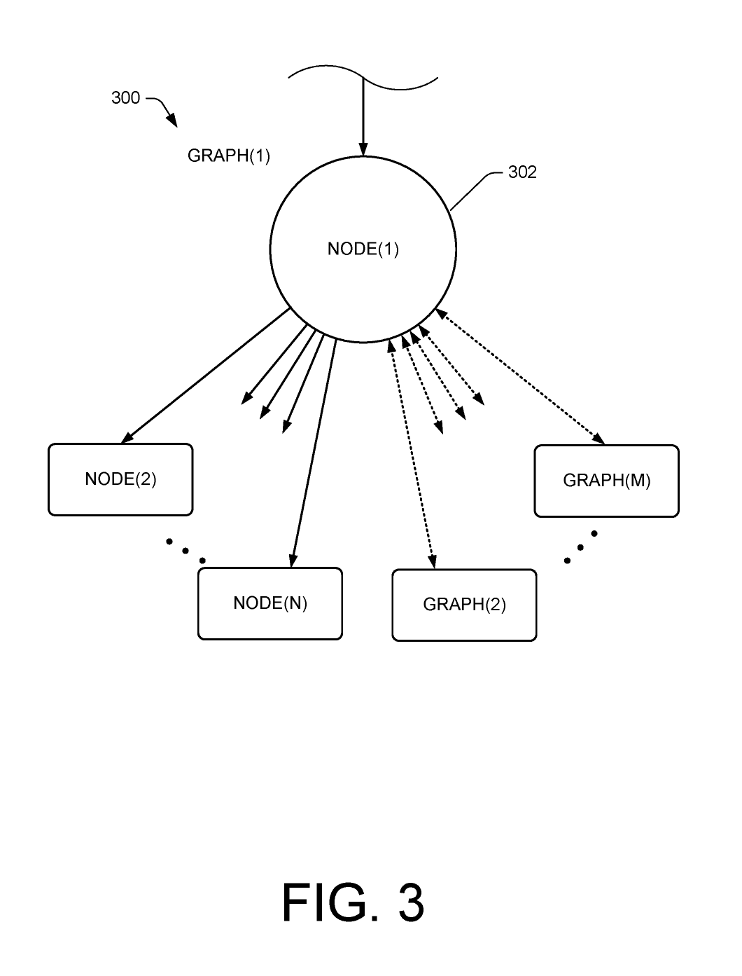

Example dialog graphs 216 are provided below and shown in FIGS. 3-5. A dialog graph creates a structured and bounded input/output protocol for interpreting requests, generating replies, and making assumptions during the dialog with a user via a user device. A dialog graph may include various nodes, some of which may be connected to one another to enable traversal of the nodes to accomplish or complete an objective (or goal). For example, a dialog graph may assist a user in selecting an item, completing an order, answering a question about an item, and/or accomplishing other objectives.

The dialog engine 206 may leverage user data 210 to interpret a request from the user and/or in generating a reply. The user data 210 may include user transaction history, user interaction history (e.g., browsing history, dialog history, etc.), user preferences, user payment information, user contact and/or address information, and/or other user information typically known to a merchant that electronically interacts with the user via a user device.

The dialog engine 206 may assist the user in identification and selection of an item using item data 212. The item data 212 may include items and associated information for items available for consumption and/or acquisition by the user. For example, the item data 212 may be a catalog of items available for acquisition from one or more different merchants and/or service providers.

The fulfillment engine 208 may determine how to fulfill an order of one or more items to enable the user to consume the item. The fulfillment engine 208 may determine one or more services to provide the item to the user, such as by physical transit of the item from an inventory location to a physical address associated with a user. The fulfillment engine 208 may determine the services based on the user data 210, such as prior services used by the user, based on the fulfillment data 214, which may indicate services available for fulfillment, among other information For example, some services may be only available to certain users, such as users within certain geographical boundaries, subscribers, and/or other users. This information may be stored in the fulfillment data 214 and/or determined in part by the user data 210.

The fulfillment engine 208 may also determine fulfillment details, such as a time slot for delivery, a type of transit (e.g., standard, priority, next day, same day, etc.). The fulfillment engine 208 may determine the fulfillment details based on the user data 210 and/or the fulfillment data 214.

The following description and examples provide further details of operation and functionality of the dialog engine 206, the fulfillment engine 208, and/or other operations of the VAS 102.

The dialog engine 206 is described further below with reference to FIGS. 3-5, which show illustrative dialog graphs. The nature of voice input is free-form, and thus the complex input space increases the possibility of unexpected behaviors or interpretations, which enables dialog having non-deterministic input received from a user, such as by selecting an entry node into a graph from at least a first entry node and a second entry node. The dialog engine 206 relies on voice, which is a low bandwidth interface, and focuses on providing important and actionable information with a concise reply, and in a natural dialog manner.

Dialogs in a shopping domain typically consist of multiple turns involving:
Lists of information (products, pricing, delivery times, etc.).
Confirmation by the user, to ensure disclosure and security.
Cart/multi-item purchase building.

The context of a shopping dialog taking place across multiple turns can then be referenced and acted upon by the user at any point the user is given control via the dialog engine 206. To handle such requests by the user, the dialog engine 206 is configured to be capable of switching context within the shopping domain, while preserving past state information. The state of a shopping dialog may be managed in the interaction model 218, describing the history of turns given user input and any system executions on behalf of the user.

The dialog engine 206 and/or the fulfillment engine 208 may employ machine learning algorithms as discussed herein. The machine learning algorithms may include supervised learning algorithms (e.g., convolutional neural network model, artificial neural networks, Bayesian statistics or networks, Gaussian process regression, logistic model trees, support vector machines, etc.), unsupervised learning algorithms (e.g., artificial neural networks, association rule learning, hierarchical clustering, cluster analysis, etc.), deep learning algorithms, and/or any learning algorithms. In various embodiments, training data may be generated as input for a machine learning algorithm that is deployed for use by the dialog engine 206 and/or the fulfillment engine 208. As an example, the assumption module 222 may use user feedback associated with incorrect assumptions to train the assumption module 222 to improve assumption accuracy. For example, if an assumption has an error rate outside of a threshold range, the assumption module 222 may be retrained. In some embodiments, training may be performed on an ongoing basis, such as using correction data, among other possible data, as training data.

FIG. 3 is a block diagram of an illustrative dialog graph 300 that includes an example node 302. The node 302, shown as “node(1)” in FIG. 3 may represent a first or intermediate node within a dialog graph, which may lead to additional nodes, such as node(2)-(N) and/or to additional graphs, such as graph(2)-(M).

The node 302 may represent a location within a dialog, such as a point in a dialog where user input is expected via a voice request. The outputs (e.g., downstream paths) of the node 302 may be created and/or selected based on anticipated outcomes or edges likely at the particular node. For example, in a shopping experience, after a user receives information about a product (e.g., Personal Assistant System: “I found a red shirt, size large, for $9.99”), the graph 300 may advance to the node 302 where additional edges/outcomes are anticipated. For example, the dialog may include nodes to facilitate providing dialog and processing in response to requests about item attributes, quantity available, user reviews, inquiries about prior items or topics discussed in the dialog, payment options, delivery options, and so forth. Typically, the edges/outcomes are predetermined based on conventional dialog and language usage. For example, a dialog would expect a selection of a product before a selection of a size in most situations. Graphs may be constructed by identifying likely requests or other using inputs through analysis of many different dialogs or user interactions, which may be used to determine the nodes to be used in a particular graph.

In some embodiments, some of the processing of dialog and processing requests may be fulfilled by utilizing another, different graph. For example, a payment graph may be used to process payment, a cart graph may be used to manage a cart, a fulfillment graph may be used to manage fulfillment options (e.g., when to delivery, which merchant to fulfill, etc.), and so forth. In various embodiments, the dialog may “jump”, via a call, from a graph, such as graph(1) to a different graph, such as graph(2), possibly without an explicit user request to jump to a different graph. The dialog may then advance by traversing nodes that correspond to graph(2) to complete a sub-process. At the completion of graph(2), or at some node in graph(2), the dialog may be directed back to graph(1), possibly at a same node or near a same node as where graph(1) was last accessed. This may enable creation of graphs to perform discrete functions, which may be called by other graphs in a way that is analogous to calling of sub-functions in conventional programing languages. As an example, a user may add an item to a cart using a first graph and then may ask for a dollar total for items in a cart, which may cause the VAS to jump to a different graph (e.g., a cart graph, etc.) to process the pending request for the total dollar amount.

In accordance with various embodiments, the dialog engine 206 may make assumptions at various nodes and/or graphs during the execution of a dialog by leveraging user data, prior interaction (dialog) data, and/or other data. As used herein, the term “assumption” includes generating conclusion based at least in part on a confidence score or consideration. For example, when the dialog includes a request of “add laundry detergent to my order”, the dialog engine may access prior purchase information to analyze in generating a selection of a brand and size for the laundry detergent. Thus, the dialog engine may assume the user desires the same laundry detergent as previously purchased. The dialog engine may confirm this at a later time. In another example, the dialog may include a request of “how much was that last item?”. Here, the dialog engine may analyze and reference prior dialog to determine the last item (e.g., laundry detergent), and may respond according (e.g., “The laundry detergent is $15.99.” Thus, the dialog engine may assume the user's use of “last item” is the “laundry detergent”, and not some other item referenced by the user or pertaining to a dialog with the dialog engine.

In some embodiments, the dialog engine may provide verification information at nodes that are downstream from a particular node, such as the node 302. For example, a user may request the laundry detergent as discussed above in an earlier example, but without specifying a brand, size, or price. Further, the dialog engine may not immediately provide all relevant information about the size, brand, or price in a response to the user's request. For example, the dialog engine may provide an acknowledgement as follows: “I added Tide® brand detergent to your order”. However, at a subsequent node, possibly via a different graph, the dialog engine may confirm a size and/or price of the laundry detergent, for example. By providing verifications downstream, but not necessarily immediately, the dialog engine may enable a more natural and streamlined dialog with a user. As the user interacts with the dialog engine over time, the dialog engine may increase confidence in assumptions and may reduce or abbreviate verifications of data. For example during a first interaction, the dialog engine may direct the user to nodes to verify most or all information about a product or order. However, in a later interaction, such as after multiple orders using the voice assistant system, the dialog engine may streamline dialog and only verify information that has a low confidence score, which may be computed based on prior interaction with the user, for example. In contrast, repeat orders of items like laundry detergent may not prompt a verification via a downstream node when the user has previously ordered this item using the voice assistant system and the item has a high confidence score as being a correct item to fulfill a particular request. The confidence score may be generated, at least partly, based on prior history of consumption of an item, prior confirmation of the item, and/or other interaction data associated with the item or similar items. For example, if the user has a transaction history that include purchase of all shirts in a size of large, then selection of a shirt may be assumed, by the dialog engine, to be a request for the shirt in a size of large with a relatively high confidence value since the shirt size of large has a high confidence score. The confidence score may determine whether a confirmation is provided or how a confirmation is provided to a user to confirm adding the size large shirt to a cart. For example, a low confidence score may prompt a tconfirmation whereas a high confidence score may not prompt a confirmation or may prompt a shortened or abbreviated confirmation of the item and/or attributes of the items.

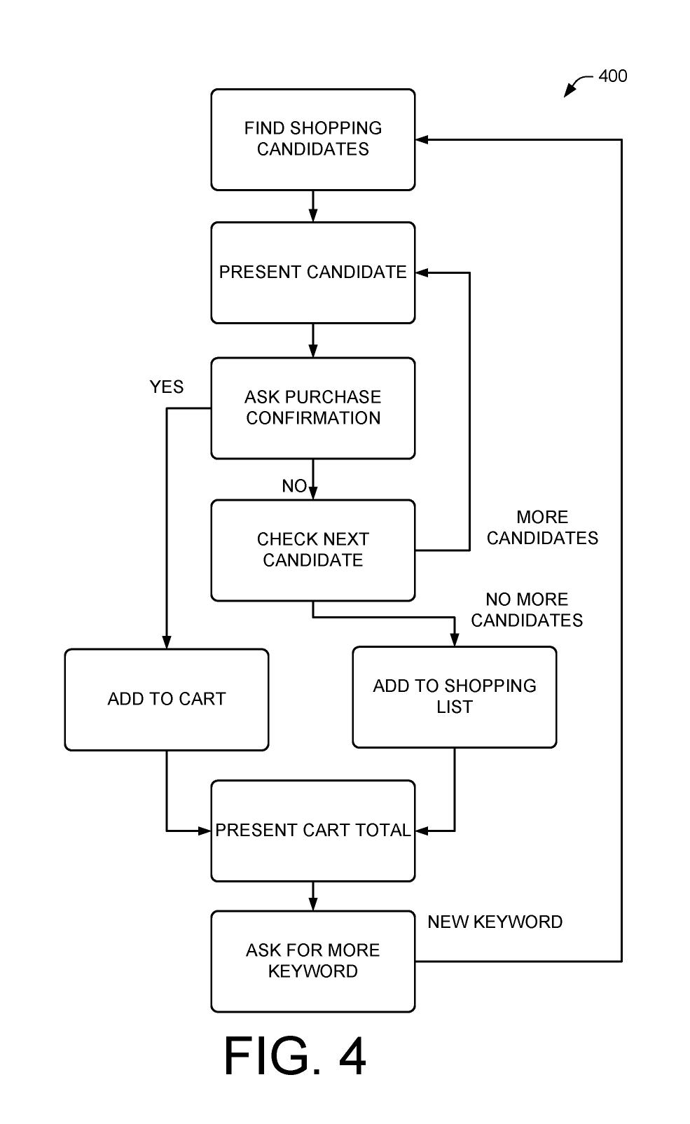

FIG. 4 shows a dialog graph 400. An example state schema is provided below, which enable interaction and/or traversal of the dialog graph 400.

```
State Schema
{
  turns: list {
    input: {
      intent
      confirmation
      slots
      confidence
    }
    executions: list {
      timestamp
      name
      ...
    }
  }
}
```

An example traversal through the dialog graph 400 may proceed as follows.
User: VAS, order me a kindle.
VAS: I found Fire Tablet, Black. It's $49.99 before tax. Would you like to buy it?
User: No.
VAS: I also found Kindle Paperwhite E-reader. It's $119.99 before tax. Would you like to buy it?
User: Yes.
VAS: Your order total is $131.39 including tax. Would you like anything else?

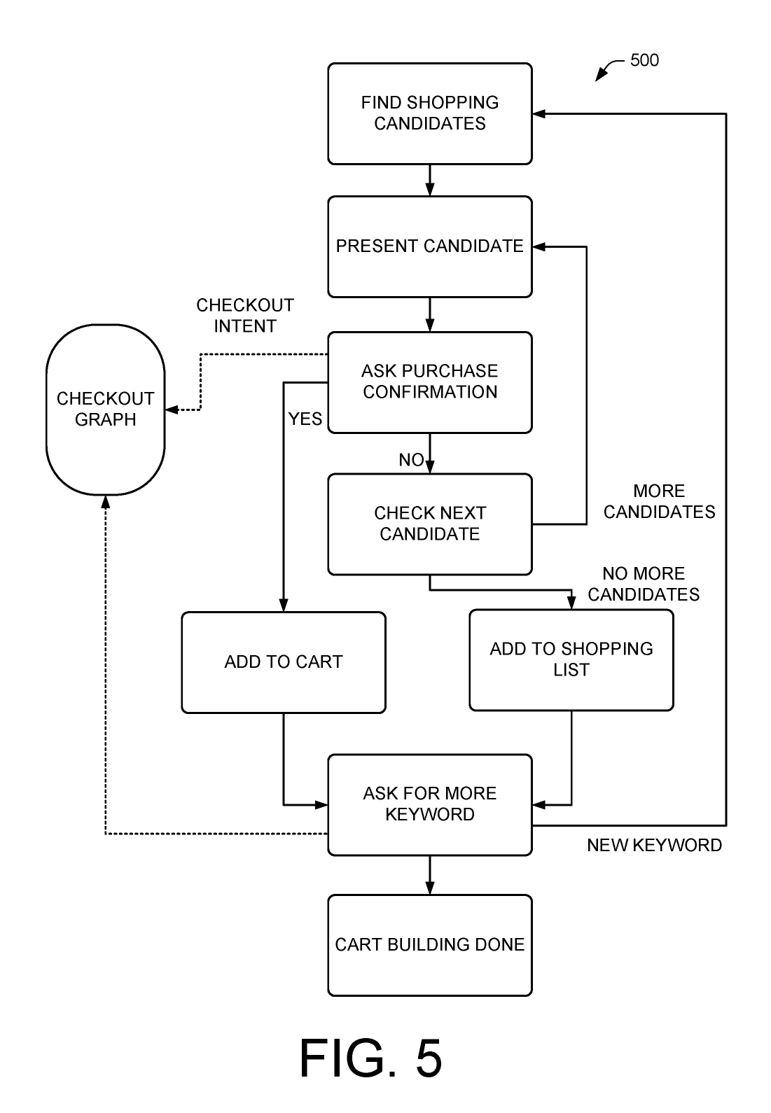

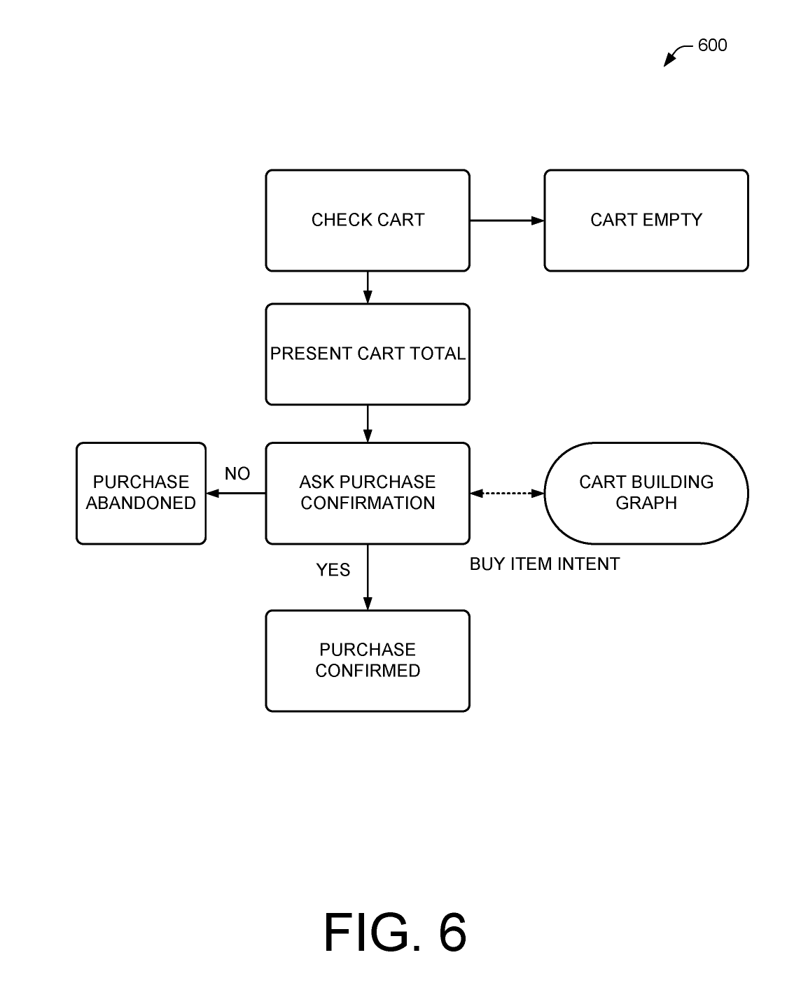

The dialog graph 400 may be a self-contained graph that includes all possible edges for each node, and includes all nodes to complete a task and enable interaction with a user via dialog. Thus, at each node, all possible edges and/or actions are determined in the dialog graph 400, which does not have access to other dialog graphs. As an example, at any given node, a user may ask a question such as “what is my cart total now?”. For the dialog engine 206 to effectively reply to that question, each node in the dialog graph 400 would have to include edges that facilitate a response to that question. In contrast, a first dialog graph may make a call to a second dialog graph to accomplish some predetermined task, which is described below and shown in FIGS. 5 and 6.

The state of a shopping dialog may be managed in an interaction model, describing the history of turns given user input, any system executions on behalf of the user. Additionally, the intents traversed in the dialog may be managed in a stack, which may include different graphs having at least some different nodes. Previously traversed intents (e.g., nodes) that are resumable may be merged if associated with one another. An example schema follows, which describes interaction between a first dialog graph 500 shown in FIG. 5 and a second dialog graph 600 shown in FIG. 6.

```
State Schema
{
  creationTime
  customerId
  interactionId
  turns: list {
    turnId
    input: {
      intent
      confirmation
      confidence
      slots
    }
    executions: list {
      timestamp
      name
      ...
    }
  }
  focus: list {
    intent
    startTime
    startTurnId
    lastTurnId
    resumable
  }
}
```

An example dialog using the first dialog graph 500 and second dialog graph 600 shown in FIG. 6 follows.
User: VAS, order me a kindle. <BUILD_CART intent>
VAS: I found Fire Tablet, Black. It's $49.99 before tax. Would you like to buy it?
User: Yes.
VAS: OK, added to your cart. Would you like anything else?
User: Yeah I want a kindle charger.
VAS: I found Store X 9W PowerFast USB Charger. It's $19.99 before tax. Would you like to buy it?
User: No.
VAS: OK, I've added kindle charger to your shopping list. Would you like anything else?
User: I want to checkout. <Context switch to CHECKOUT intent>
VAS: Your cart total is $49.99. With tax, your total comes out to $54.74. Would you like me to place this order?
User: Actually, I want to add a kindle fire case. <Context switch back to BUILD_CART intent>
VAS: I found Store X Fire Case, Black. It's $24.99 before tax. Would you like to buy it?
User: Hmm nevermind, just checkout. <Context switch back to CHECKOUT intent>
VAS: Your cart total is $49.99. With tax, your total comes out to $54.74. Would you like me to place this order?
User: Yes.
VAS: OK, order placed.

An example intent stack associated with the first dialog graph 500 shown in FIG. 5 and second dialog graph 600 shown in FIG. 6 follows.

```
focus: [{
  intent: BUILD_CART
  startTime: ...
  startTurnId: 1
  endTurnId: 4
}]
First context switch to CHECKOUT intent
focus: [{
  intent: BUILD_CART
  startTime: ...
  startTurnId: 1
  endTurnId: 4
}, {
  intent: CHECKOUT
  startTime: ...
  startTurnId: 5
  endTurnId: 5
}]
Second context switch back to BUILD_CART intent, merge intent
focus: [{
  intent: BUILD_CART
  startTime: ...
  startTurnId: 1
  endTurnId: 6
}, {
  intent: CHECKOUT
  startTime: ...
  startTurnId: 5
  endTurnId: 5
}]
Third context switch back to CHECKOUT intent, merge intent
focus: [{
  intent: BUILD_CART
  startTime: ...
  startTurnId: 1
  endTurnId: 6
}, {
  intent: CHECKOUT
  startTime: ...
  startTurnId: 5
  endTurnId: 8
}]
```

Example dialog states using the first dialog graph 500 shown in FIG. 5 and second dialog graph 600 shown in FIG. 6 follow.

```
1.1 Single intent dialog state (shown in FIG. 4)
{
  turns: [{
    input: {
      intent: “PURCHASE”
      confidence: 1.0
      slots: {
        keyword: “kindle”
      }
    }
    executions: [{
      name: “FIND_SHOPPING_CANDIDATES”
      keyword: “kindle”
      candidates: [{
        ID: “B00TSUGXKE”
        price: “$49.99”
        title: “Fire Tablet, Black”
      }, {
        ID: “B00OQVZDJM”
        price: “$119.99”
        title: “Kindle Paperwhite E-reader”
      }]
    }, {
      name: “PRESENT_CANDIDATE”
      candidate: {
        ID: “B00TSUGXKE”
        price: “$49.99”
        title: “Fire Tablet, Black”
      }
      prompted: “I found Fire Tablet, Black. It's $49.99 before tax.”
    }, {
      name: “ASK_PURCHASE_CONFIRMATION”
      prompted: “Would you like to buy it?”
    }]
  }, {
    input: {
      intent: “PURCHASE”
      confidence: 1.0
      slots: {
        keyword: “kindle”
        confirmation: “no”
      }
    }
    executions: [{
      name: “CHECK_NEXT_CANDIDATE”
      hasNextCandidate: true
      candidate: {
        ID: “B00OQVZDJM”
        price: “$119.99”
        title: “Kindle Paperwhite E-reader”
      }
    }, {
      name: “PRESENT_CANDIDATE”
      candidate: {
        ID: “B00OQVZDJM”
        price: “$119.99”
        title: “Kindle Paperwhite E-reader”
      }
      prompted: “I also found Kindle Paperwhite E-reader.
It's $119.99 before tax.”
    }, {
      name: “ASK_PURCHASE_CONFIRMATION”
      prompted: “Would you like to buy it?”
    }]
  }, {
    input: {
      intent: “PURCHASE”
      confidence: 1.0
      slots: {
        keyword: “kindle”
        confirmation: “yes”
      }
    }
    executions: [{
      name: “PRESENT_ORDER_TOTAL”
      orderTotal: “$131.39”
      prompted: “Your order total is $131.39 including tax.”
    }, {
      name: “ASK_FOR_MORE_KEYWORD”
      prompted: “Would you like anything else?”
    }]
  }]
}
1.2 Dialog state context switching between intents
(as shown in FIGS. 4 and 5)
{
  turns: [{
    turnId: 1
    input: {
      intent: “BUILD_CART”
      confidence: 1.0
      slots: {
        keyword: “kindle”
      }
    }
    executions: [{
      name: “FIND_SHOPPING_CANDIDATES”
      keyword: “kindle”
      candidates: [{
        ID: “B00TSUGXKE”
        price: “$49.99”
        title: “Fire Tablet, Black”
      }, {
        ID: “B00OQVZDJM”
        price: “$119.99”
        title: “Kindle Paperwhite E-reader”
      }]
    }, {
      name: “PRESENT_CANDIDATE”
      candidate: {
        ID: “B00TSUGXKE”
        price: “$49.99”
        title: “Fire Tablet, Black”
      }
      prompted: “I found Fire Tablet, Black. It's $49.99 before tax.”
    }, {
      name: “ASK_PURCHASE_CONFIRMATION”
      prompted: “Would you like to buy it?”
    }]
  }, {
    turnId: 2
    input: {
      intent: “BUILD_CART”
      confidence: 1.0
      confirmation: “yes”
      slots: {
        keyword: “kindle”
      }
    }
    executions: [{
      name: “ADD_TO_CART”
      candidate: {
        ID: “B00TSUGXKE”
        price: “$49.99”
        title: “Fire Tablet, Black”
      }
      prompted: “OK, added to your cart.”
    }, {
      name: “ASK_FOR_MORE_KEYWORD”
      prompted: “Would you like anything else?”
    }]
  }, {
    turnId: 3
    input: {
      intent: “BUILD_CART”
      confidence: 1.0
      slots: {
        keyword: “kindle charger”
      }
    }
    executions: [{
      name: “FIND_SHOPPING_CANDIDATES”
      keyword: “kindle charger”
      candidates: [{
        ID: “B00QFQRELG”
        price: “$19.99”
        title: “Store X 9W PowerFast USB Charger”
      }]
    }, {
      name: “PRESENT_CANDIDATE”
      candidate: {
        ID: “B00QFQRELG”
        price: “$19.99”
        title: “Store X 9W PowerFast USB Charger”
      }
      prompted: “I found Store X 9W PowerFast USB Charger.
It's $19.99 before tax.”
    }, {
      name: “ASK_PURCHASE_CONFIRMATION”
      prompted: “Would you like to buy it?”
    }]
  }, {
    turnId: 4
    input: {
      intent: “BUILD_CART”
      confidence: 1.0
      confirmation: “no”
      slots: {
        keyword: “kindle charger”
      }
    }
    executions: [{
      name: “ADD_TO_SHOPPING_LIST”
      keyword: “kindle charger”
      prompted: “OK, I've added kindle charger to your shopping list.”
    }, {
      name: “ASK_FOR_MORE_KEYWORD”
      prompted: “Would you like anything else?”
    }]
  }, {
    turnId: 5
    input: {
      intent: “CHECKOUT”
      confidence: 1.0
      slots: {
      }
    }
    executions: [{
      name: “CHECK_CART”
      items: [{
        ID: “B00TSUGXKE”
        price: “$49.99”
        title: “Fire Tablet, Black”
      }]
      total: “$49.99”
    }, {
      name: “PRESENT_CART_TOTAL”
      total: “$49.99”
      prompted: “Your cart total is $49.99.”
    }, {
      name: “ASK_PURCHASE_CONFIRMATION”
      total: “$49.99”
      tax: “$4.75”
      prompted: “With tax, your total comes out to $54.74. Would you
like me to place this order?”
    }]
  }, {
    turnId: 6
    input: {
      intent: “BUILD_CART”
      confidence: 1.0
      slots: {
        keyword: “kindle fire case”
      }
    }
    executions: [{
      name: “FIND_SHOPPING_CANDIDATES”
      keyword: “kindle”
      candidates: [{
        ID: “B00ZGUYN1Q”
        price: “$24.99”
        title: “Fire Case, Black”
      }, {
        ID: “B018DWN16Q”
        price: “$29.99”
        title: “Kindle New Fire 7 2015 Slim Case, Mint Green”
      }]
    }, {
      name: “PRESENT_CANDIDATE”
      candidate: {
        ID: “B00ZGUYN1Q”
        price: “$24.99”
        title: “ Fire Case, Black”
      }
      prompted: “I found Fire Case, Black. It's $24.99 before tax.”
    }, {
      name: “ASK_PURCHASE_CONFIRMATION”
      prompted: “Would you like to buy it?”
    }]
  }, {
    turnId: 7
    input: {
      intent: “CHECKOUT”
      confidence: 1.0
      slots: {
      }
    }
    executions: [{
      name: “CHECK_CART”
      items: [{
        ID: “B00TSUGXKE”
        price: “$49.99”
        title: “Fire Tablet, Black”
      }]
      total: “$49.99”
    }, {
      name: “PRESENT_CART_TOTAL”
      total: “$49.99”
      prompted: “Your cart total is $49.99.”
    }, {
      name: “ASK_PURCHASE_CONFIRMATION”
      total: “$49.99”
      tax: “$4.75”
      prompted: “With tax, your total comes out to $54.74. Would you
like me to place this order?”
    }]
  }, {
    turnId: 8
    input: {
      intent: “CHECKOUT”
      confidence: 1.0
      confirmation: “yes”
      slots: {
      }
    }
    executions: [{
      name: “PURCHASE_CONFIRMED”
      prompted: “OK, order placed.”
    }]
  }]
}
```

In some embodiments, actions or interactions in the dialog may be associated with a timestamp and/or associated with a group of actions for a particular dialog graph. When traversal of a second dialog graph occurs within or during traversal of a first dialog graph, the state may be determined based on the time stamps. In some embodiments, once a dialog graph is competed (e.g., traversed to a completion or endpoint), then the state may no longer be associated with that dialog graph or that dialog graph may be deprioritized below a current dialog graph having more recent activity. This ordering or prioritizing of actions may impact a state, and may enable the dialog engine to track state, predict user intent, and/or provide accurate or satisfactory replies to user requests.

The following description and examples provide further details of operation and functionality of the fulfillment engine 208. Shoppers have personal preferences when it comes to picking a store for specific shopping needs and the picks may vary based on several factors. For instance—the parameters used for picking a restaurant (cuisine, quality of food, pricing, service time etc.) may be very different from picking a grocery store (selection, pricing etc.) or a service provider store.

With the advent of internet & ecommerce, several stores started registering their online presence through websites (and/or apps) and started personalizing their online store experience to help customers find the right set of products quicker. However, the onus of researching & finding the appropriate online store for a given product (or a set of products) was still left to the customer who would use various discovery mechanisms to find their favorite stores for specific shopping needs.

With further advances in technology (NLP, Machine Learning etc.), the world is now occupied by intelligent personal assistants like Alexa®, Siri®, Cortana® etc. Some of these assistants today, provide a voice only natural language based communication interface. This interface is hard for browsing and discovery of products & stores and therefore increases the need for smart discovery. While the problem of finding the right products given a store has several solutions available, the focus is on finding the right store(s) given a product (or a list of products).

The following discussion provides challenges faced and solution(s) to those challenges in the context of the VAS 102 using the fulfillment engine 208 in the context of grocery shopping. However, a similar solution could be easily extended to several use-cases beyond grocery shopping (e.g., buying food from restaurants, apparels from branded stores, services like ride services, etc.). Also note that the solution can be extended beyond stores available on a marketplace to broadly any store.

A customer would like to order her groceries and household supplies using the VAS 102. The VAS 102 has the capability of ordering products from a first marketplace, along with a special store.
1) E.g., the first marketplace has an excellent selection of grocery but has limited coverage in terms of cities and also requires $299. Some services may require a $X minimum order to avoid any shipping costs. Some services provide an additional advantage of unattended delivery.
2) On the other hand some services have no additional membership costs, may deliver in a short period of time (e.g., within 2 hours but requires $Y minimum and has limited selection of grocery). Some services, again, have limited coverage in terms of cities and also requires attended delivery for groceries.
3) Other services have no additional membership, delivery in a short time frame (e.g., within 2 hours but has a different order minimum and items might be marked-up hence costly). They may require attended delivery.
4) The main marketplace may not sell groceries and might return unexpected results (ex: Banana chips for bananas).

In the above use-cases, a user may say “VAS, buy bananas.” The fulfillment engine 208 may then determine a store to use to fulfill the item. Note that different customers may have different preferences (some might be willing to pay the price for a first service to get the convenience of unattended delivery, some might prefer a second service with attended while a few others might just be ok with a default service). In some embodiments, the service selected by the fulfillment engine 208 may change as more items are selected via the dialog engine 206 to enable consolidation of service for fulfillment.

A user specific service (or store) example is follows. A simple solution that comes to mind is to offload the store selection to the customer and let her specify it (“VAS, buy bananas from store X”). However, this runs into a few problems:
1) Without the knowledge of what stores are supported, customers might start using the entire universe of grocery shopping stores. For example:
   Me) “VAS buy bananas from Safeway”
   VAS) “Sorry, I can't order from Safeway yet. [Optional: I can only grocery-shop from Vons and Fresh in your area]”
One might think of building a way to provide a list of supported stores here (as shown in italics above) but the solution quickly becomes un-scalable if the list of stores grows. Imagine you want Pizza and VAS knows many restaurants near your place that can deliver pizza but not the one that you are asking for.
2) A few rogue users might intentionally provide wrong inputs (“VAS buy Kindle Fire from Pizza Hut”) resulting in a response like (“Pizza Hut does not sell Kindles yet”)
3) Many users might just expect an “Intelligent Personal” assistant to know the store that they shop from and might just say “VAS buy bananas” and expect VAS to figure the store out.

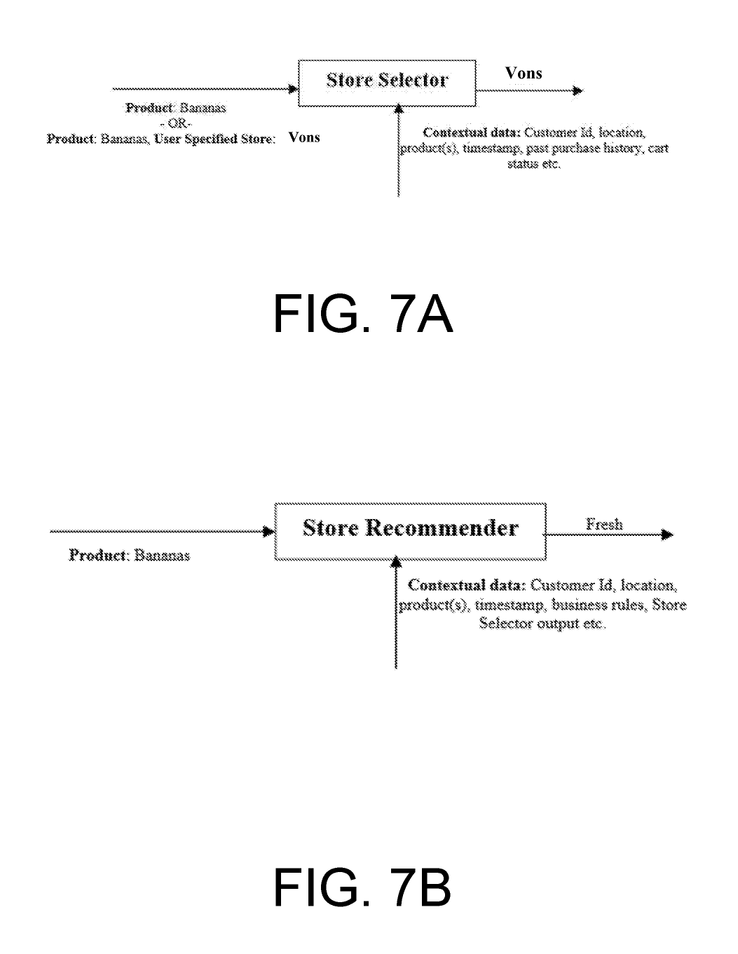

These are just a few examples that might lead VAS to provide a sub optimal dead-end experience. Next, high level approaches to solving this problem are discussed. A personalized store selector and recommender may provide a solution for implementation by the fulfillment engine 208. Two possible sub-systems may be used. At a high level, a Store Selector determines the store a user wanted to shop from as shown in FIG. 7A.

A simple implementation of Store Selector could use past purchase data to pre-compute stores popular with the customer for specific shopping need (Ex: Grocery->store X, Italian Food->Little Italy, and Apparels->store Y, etc.). The pre-computed stores are used in absence of a user-specified store. A more sophisticated approach could use a variety of signals to come up with a learned model as indicated in table below (but not limited to these):
Customer Signals
   Program/Store Eligibility: Location Serviceability, Payment Instrument requirements (ex: Cannot shop using AMEX etc.)
   Program/Store Membership: Does the store require memberships or other eligibility criteria to be met for a customer to be able to shop.
   Program Usage: Has the customer shopped in the store before. Items that he purchases in the store.
   Voice Shopping Usage: Has the customer shopped in the store before using the channel/device he is currently shopping with.
Item Signals:
   Store Affinity: Is the specific product in question sold on this store. (ex: Some stores may specialize in Apparels, some in Wine/Spirits and others in food etc.
   Offer Quality: What is the best offer for the product from a given store (Pricing, Deals, Customer Service ratings etc.).
Order Signals
   Pending Order or Cart: Customer might already have a running cart (or an order pending delivery) with the store. It might be faster/price effective to add the item to the existing order/cart.

However, the fulfillment engine 208 might not be able to predict the store all the time. Alternately, the user's choice of store for his shopping needs might be sub-optimal and VAS might want to cross sell another store. This is where a store recommender, a component of the fulfillment engine 208, may be deployed.

Personalized Store Recommender: Store recommender may compute a best possible or ideal store for the product(s) you are looking for. The output from Recommender might be used by VAS to recommend a different store(s) as an option in case Store Selector has no suggestions. VAS may also decide to use the recommended store as an upsell opportunity even if Store Selector had a suggestion (ex: Store Selector says that the store is Vons but Recommender suggests “Fresh”, an example service for fulfillment used herein. VAS might upsell Fresh to customer while providing the reason for its Upsell). FIG. 7B shows an example flow for the store recommender.

A naive implementation of Store Recommender could be a simple rules engine. For instance, one possible algorithm for store recommendations could be:
Identify the Store Type from Product(s) Query (ex: {Banana, Apples, Kale}->Grocery Store)
From the universe of supported StoreType=GroceryStores (ex: Store X, store Y, etc.) find the subset stores that are available in Customer's region.
Rank the stores based on a pre-computed (or business provided) Store Preference list.
[Optional] Check if customer is eligible to shop in the stores (for ex: Fresh may get eliminated if the customer is not store Y Member).
Present the topmost store as an option (or upsell) and register customer response (accepted, rejected) as feedback signal
[Optional] Use the feedback signal to prioritize stores in future recommendation attempts.

While the above is a simple implementation for Store Recommendation, a more sophisticated machine learning model could use sophisticated signals like Store Pricing (including but not limited to offer price, deals, cashbacks), Store Ratings etc. along with above factors to recommend stores that might be better for customer's shopping needs.

Various examples of implementation of store selection and/or recommendation by the fulfillment engine 208 follow. Basic principles of decision making by the fulfillment engine 208 follow:
1. Customers can request a format in a simple, intuitive, and natural way. If the customer knows which store they want to shop from, they can tell VAS in a natural way. Even if they don't know of the store, customers can easily specify their needs (e.g. “I need it urgently” or “Can I get it sooner?”).
2. Optimized for order building. We believe that customers tend to grocery shop from a list of items. If unclear, we bias towards choosing a store and ordering, only when the customer indicates they are ready to order.
3. Best Store selection first. We will bias towards the store that provides best value to the customer, except when doing so would result in a worse customer experience.

The above principles include the following assumptions:
1. Fresh customers prefer Fresh for majority of their shopping use cases.
2. Customers do not know what shopping formats are available. They would prefer that VAS pick the best available format.
3. We can offer voice shoppers a simple, zero touch onboard to Fresh.

### Frequently Asked Questions

How will VAS pick a store for the customer?
   Store Selection Use Cases, and dialogs:
Customer Scenario 1: Customer is a Fresh member, and is in a location covered by Store Y.
Action: Customer requests to buy a grocery item.
   Customer: “VAS, I need milk” [Customer has ordered milk on Fresh before]
   VAS: “I've added milk to your next Fresh order. What else would you like?”
   Customer: “Parmigiano Reggiano.” [Customer has never order this on Fresh]
   VAS: “Parmigiano Reggiano, 0.41 lb. is $6.37. Want to add it to your Fresh order?”
   Customer: “Yes.”
   VAS: “Got it. What else?”
   Customer: “Nothing.”
   VAS: “Ok, your Fresh order total is $18.21. You don't have a delivery scheduled yet. Tell me to schedule your fresh delivery when you are ready.”
Action: Customer requests to buy a consumable item.
   Customer: “VAS, order toilet paper”
   VAS: “Top choice is Angel Soft, 22 pack, for $15.32. Should I add it to your Fresh order?”
   Customer: “Yes.”
   VAS: “Got it. What else?”
   Customer: “Nothing.”
   VAS: “Ok, your Fresh order total is $18.21. You don't have a delivery scheduled yet. Tell me to schedule your fresh delivery when you are ready.”
Action: Customer requests to buy a non-grocery item which is available on Fresh, as well as Now and Marketplace. Item is below order minimum.
   Customer: “VAS, order an iPhone 7 charger”
   VAS: “Basics 6 ft lightning cable charger is $9.99. Want to add it to your Fresh order?”
   Customer: “Can I get it sooner?”
   VAS: “Sure, I can order it with Prime 2 day delivery. Or, I can order from Store Y, with a free 2-hour delivery and a $20 minimum. Which would you prefer, Prime 2-day, or Store Y?”
   Customer: “Order it from Prime”
   VAS: “Great. Order placed. It will be delivered in 2 days.”
Action: Customer requests to buy a non-grocery item which is available on Fresh, as well as Store Y and Store X. Item is above the Store Y order minimum.
   Customer: “VAS, order a TP Link smart switch”
   VAS: “TP Link smart switch is $39.99. Want to add it to your Fresh order?”
   Customer: “Can I get it sooner?”
   VAS: “Sure, I can order it from Store Y, with free 2-hour delivery between 6 and 8 PM today. Should I order it??”
   Customer: “Yes.”
   VAS: “Great. Order placed. It will be delivered between 6 and 8 PM today.”
Action: Customer requests an item not available on Fresh. Item is available on both Store X and Store Y.
   Customer: “VAS, order an Echo Dot”
   VAS: “Store X has Echo Dot for $51.39. Would you like to order it?”
   Customer: “Yes”
   VAS: “This item qualifies for free 2-hour delivery between 6 and 8 PM today, from Store Y. Would you like to order from Store Y?”
   Customer: “Yes.”
   VAS: “Great. Order placed. It will be delivered between 6 and 8 PM today.”
Customer Scenario 2: Customer is not a Fresh customer, but lives in a Fresh and Store Y location.
Action: Customer requests to buy a grocery item. Customer accepts Fresh sign up offer.
   Customer: “VAS, I need milk”
   VAS: “Ok, noted. What else would you like?”
   Customer: “Eggs.”
   VAS: “Got it. What else?”
   Customer: “That's it.”
   VAS: “I can order these items from Fresh and have it delivered tonight. You can shop the complete selection of grocery items for only $14.99 per month, and receive free same day or next day delivery for orders over $40. Do you want me to start your free 6-month trial?”
   Customer: “Yes”
   VAS: “Great! I've added your items to your Fresh cart, and your total is $8.21. You can schedule your Fresh delivery by saying ‘Schedule my fresh delivery’.”
Action: Customer requests to buy a grocery item. Customer denies Fresh sign up offer.
   Customer: “VAS, I need milk”
   VAS: “Ok, noted. What else would you like?”
   Customer: “Eggs.”
   VAS: “Got it. What else?”
   Customer: “That's it.”
   VAS: “I can order these items from Fresh and have it delivered tonight. You can shop the complete selection of grocery items for only $14.99 per month, and receive free same day or next day delivery for orders over $40. Do you want me to start your free 6-month trial?”
   Customer: “No”
   VAS: “No problem. I can also order these items from your local Vons store, using Store Y. Vons orders can be delivered today between 6 and 8 PM, and require a $20 order minimum. Do you want to order it?”
   Customer: “Yes”
   VAS: “Great. Your current total is $8.21. What else would you like?”
   <Continues building order>
Action: Customer requests to buy a non-grocery item which is available on Fresh, Store Y, and Store X. Item is below the Store Y order minimum.
   Customer: “VAS, order an iPhone 7 charger”
   VAS: “Basics 6 ft lightning cable charger is $9.99. Should I order it?”
   Customer: “Yes”
   VAS: “Great. Order placed. It will be delivered in 2 days.”
Customer requests to buy a non-grocery item which is available on Fresh, Store Y, and Store X. Item is above the Store Y order minimum.

Customer: “VAS, order a TP Link smart switch”
VAS: “TP Link smart switch is $39.99. Should I order it?”
Customer: “Yes.”
VAS: “This item qualifies for free 2-hour delivery between 6 and 8 PM today from Store Y. Would you like to order from Store Y”
Customer: “Yes.”
VAS: “Great. Order placed. It will be delivered between 6 and 8 PM today.”
Customer requests to buy a consumables item, which is available on Fresh, Store Y, and Store X.
   Customer: “VAS, order toilet paper”
   VAS: “Store X's choice is Angel Soft 22 rolls, for $15.21. It will be delivered in 2 days. Should I order it?”
   Customer: “Yes”
   VAS: “Great. Order placed. It will be delivered in 2 days.”
Scenario 3: Customer lives in location not covered by Fresh, but covered by Store Y.
Action: Customer requests to buy a grocery item.
   Customer: “VAS, I need milk”
   VAS: “Ok, noted. What else would you like?”
   Customer: “Eggs.”
   VAS: “Got it. What else?”
   Customer: “That's it.”
   VAS: “I can also order these items from Store Y. Store Y can deliver today between 6 and 8 PM, and requires a $20 order minimum. Do you want to order it?”
   Customer: “Yes”
   VAS: “Great. Your current total is $8.21. What else would you like?”
   <Continues building order>
Customer requests to buy grocery items, which are not available on Store Y.
   Customer: “VAS, I need milk”
   VAS: “Ok, noted. What else would you like?”
   Customer: “Eggs.”
   VAS: “Got it. What else?”
   Customer: “Chicken”
   VAS: “Got it. What else?”
   Customer: “That's it.”
   VAS: “I can also order everything except Chicken from Store Y. Store Y can deliver today between 6 and 8 PM, and requires a $20 order minimum. Do you want to order it?”
   Customer: “Yes”
   VAS: “Great. Your current total is $8.21. What else would you like?”
   <Continues building order>
   VAS: “Great, order placed. It will be delivered today between 6 and 8 PM. I've put Chicken on your shopping list.”
Action: Customer requests to buy a non-grocery item which is available Store Y and Store X. Item is below the Store Y order minimum.
   Customer: “VAS, order an iPhone 7 charger”
   VAS: “Basics 6 ft lightning cable charger is $9.99. Should I order it?”
   Customer: “Yes”
   VAS: “Great. Order placed. It will be delivered in 2 days.”
Action: Customer requests to buy a non-grocery item which is available Store Y and Store X. Item is above the Store Y order minimum.
   Customer: “VAS, order a TP Link smart switch”
   VAS: “TP Link smart switch is $39.99. Should I order it?”
   Customer: “Yes.”
   VAS: “This item qualifies for free 2-hour delivery between 6 and 8 PM today from Store Y. Would you like to order from Store Y”
   Customer: “Yes.”
   VAS: “Great. Order placed. It will be delivered between 6 and 8 PM today.”
Action: Customer requests to buy a consumables item, which is available on Store Y and Store X.
   Customer: “VAS, order toilet paper”
   VAS: “Store X's choice is Angel Soft 22 rolls, for $15.21. It will be delivered in 2 days. Should I order it?”
   Customer: “Yes”
   VAS: “Great. Order placed. It will be delivered in 2 days.”

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
one or more processors; and
memory storing computer-executable instructions that, when executed, cause the one or more processors to perform acts comprising:
receiving first text associated with a first spoken request from a user, the first text indicting an item desired by the user;
determining, via the voice assistant system, a context of the first spoken request;
accessing a first dialog graph based on the context of the first spoken request;
generating a first reply to the first spoken request by traversing from a first node within the first dialog graph to a second node within the first dialog graph;
causing the first reply to be announced to the user;
receiving second text associated with a second spoken request from the user; and
calling a second dialog graph to perform an operation associated with the item.

2. The system as recited in claim 1, further comprising resuming the first dialog graph to facilitate determining another consumption request for another item.

3. The system as recited in claim 2, wherein resuming the first dialog graph occurs at an entry node in the graph selected from a first entry node or a second entry node to facilitate non-deterministic behavior of a user.

4. The system as recited in claim 1, further comprising determine the first item based at least in part on the first text associated with the first spoken request and historical order information associated with a user profile of the user.

5. The system as recited in claim 1, further comprising:
determining a confidence score associated with the first reply;
determining a description of the item to announce to the user based at least in part on the confidence score; and
causing a confirmation to the item to be announced using the description.

6. A computer-implemented method comprising:
receiving a first spoken request from a user;
determining, via a voice assistant system, a context of the first spoken request;
accessing a first dialog graph based on the context of the first spoken request;
generating a first reply to the first spoken request by traversing to a first node within the first dialog graph;
causing the first reply to be announced to the user;
receiving a second spoken request from the user after at least one intervening request that is received after the first request;
determining a context of the second spoken request based at least in part on interpretation of the first request that occurs before the intervening request;
generating a second reply to the second spoken request by traversing from the first node to a second node within the first dialog graph, the second reply based at least in part on the first request or the first reply; and
causing the second reply to be announced to the user.

7. The computer-implemented method as recited in claim 6, further comprising generating, via the first dialog graph, a consumption request of one or more items in response to at least the first spoken request or the second spoken request.

8. The computer-implemented method as recited in claim 6, further comprising calling a second dialog graph from a node associated with the first dialog graph, the second dialog graph to perform a sub-operation prior to resuming dialog processing by the first dialog graph.

9. The computer-implemented method as recited in claim 8, further comprising calling the first dialog graph from a different node associated with the second dialog graph, the first dialog graph to resume dialog at the second node or a third node.

10. The computer-implemented method as recited in claim 6, wherein the first spoken request initiates selection of an entry node of the first dialog graph, the entry node selected from at least a first entry node or a second entry node to facilitate non-deterministic behavior of a user.

11. The computer-implemented method as recited in claim 6, wherein the second node references the first reply associated with the first node to determine the second reply associated with the second node.

12. The computer-implemented method as recited in claim 6, further comprising confirming the first reply using an abbreviated confirmation that refrains from providing at least one of a brand, a size, or provider of an item.

13. The computer-implemented method as recited in claim 6, further comprising:
determining a confidence score associated with the first reply; and
determining a confirmation of the first reply based at least in part on the confidence score.

14. The computer-implemented method as recited in claim 6, further comprising:
providing a first time stamp associated with interaction with the first node;
providing a second time stamp associated with interaction with the second node; and
determining a context associated with a pronoun or an anaphora based at least in part on the first time stamp and the second time stamp.

15. A system comprising:
one or more processors; and
memory storing computer-executable instructions that, when executed, cause the one or more processors to perform acts comprising:
receiving a first spoken request from a user, the first spoken request indicating a computing action to be performed for the user;
determining, via the voice assistant system, a context of the first spoken request;
accessing a first dialog graph based on the context of the first spoken request;
generating a first reply to the first spoken request by traversing to a first node within the first dialog graph;
causing the first reply to be announced to the user;
receiving a second spoken request from the user;
calling a second dialog graph, in response to at least the second spoken request, to perform one or more sub-operations; and
calling the first dialog graph to resume dialog to complete the computing action.

16. The system as recited in claim 15, further comprising:
receiving a third spoken request from the user;
generating a third reply to the third spoken request by traversing from the first node to a third node within the first dialog graph, the third reply based at least in part on the first request or the first reply;
determining an item based at least in part on the first spoken request or the third spoken request; and
initiating an order fulfillment operation associated with the item based at least in part on the third spoken request.

17. The system as recited in claim 15, further comprising generating a third reply to the third spoken request by traversing to a third node within the first dialog graph, the third reply based at least in part on the first request or the first reply, and wherein the third node determines the third reply based at least in part on determining a pronoun or an anaphora from the first spoken request or the first reply.

18. The system as recited in claim 15, further comprising confirming the first reply using an abbreviated confirmation that refrains from providing at least one of a brand, a size, or provider of an item.

19. The system as recited in claim 15, further comprising:
determining a confidence score associated with the first reply; and
determining a confirmation of the first reply based at least in part on the confidence score.

20. The system as recited in claim 15, wherein the first dialog graph to resumes dialog at the first node or a second node.
